(19) United States
(12) Patent Application Publication
(10) Pub. No.: US 2022/0005622 A1
(43) Pub. Date: Jan. 6, 2022

(54) RADIATION SHIELDING MATERIAL

(71) Applicants: SEIBERSDORF LABOR GMBH, Seibersdorf (AT); PAPIERTECHNISCHE STIFTUNG, Heidenau (DE); HPS GMBH, München (DE)

(72) Inventors: Peter Beck, Seibersdorf (AT); Reinhard Grenz, Seibersdorf (AT); Marcin Latocha, Seibersdorf (AT); Thomas Meinen, Seibersdorf (AT); Lars Tiedemann, Seibersdorf (AT); Christoph Tscherne, Seibersdorf (AT); Marco Vuolo, Seibersdorf (AT); Michael Wind, Seibersdorf (AT); Georg Wulz, Seibersdorf (AT); Martin Zahel, Seibersdorf (AT)

(21) Appl. No.: 17/293,225

(22) PCT Filed: Nov. 11, 2019
(86) PCT No.: PCT/AT2019/060381

§ 371 Date: May 12, 2021

(30) Foreign Application Priority Data
Nov. 12, 2018 (AT) A50970/2018

(51) Int. Cl. G21F 1/08; G21F 1/10; D21F 11/00

(52) U.S. Cl. CPC G21F 1/08; D21F 11/00; G21F 1/106

(57) ABSTRACT

The present invention provides a radiation shielding material, particularly for shielding of particle radiation, comprising a fibre material and a radiation damping filler, wherein the amount of the radiation damping filler is 40 to 95 wt. % based on the dry weight of the radiation shielding material. The present invention further provides a radiation shielding structure, particularly for shielding of particle radiation, comprising a bottom layer and a top layer, wherein a hollow structure is sandwiched between the bottom layer and the top layer, wherein the hollow structure is filled with a radiation damping filler.

The invention relates to a radiation shielding material, particularly for shielding of particle radiation, comprising a fibre material and a radiation damping filler, as well as to a method for producing such radiation shielding material.

The invention further relates to a radiation shielding structure, particularly for shielding of particle radiation, comprising a bottom layer and a top layer, wherein a hollow structure is sandwiched between the bottom layer and the top layer.

Radiation shielding materials have a wide field of applications, for example aircrafts and vehicles operating within the stratosphere, orbit or on an interplanetary mission are exposed to high levels of ionizing electromagnetic and particle radiation. The measured radiation doses within aircrafts range from about 10 μSv/h to 20 μSv/h. For spacecrafts in the Earth's orbit the radiation doses are up to 100 μSv/h and comprehensive experience has been made during long-term missions on manned near earth-orbit missions and their impact on physical condition of the astronauts.

Radiation doses for spacecrafts that move outside the atmosphere and gravity of Earth are even higher. Therefore, a particular challenge is to protect human astronauts against particle radiation on interplanetary manned space missions, for example in a deep space radiation environment beyond the magnetic belt (Van-Allen-Belt) to which astronauts will be exposed on long-duration interplanetary space travels, e.g. on a manned mission to Mars.

Space radiation environments differ significantly from radiation environments on Earth, such as X-rays or terrestrial radiation. Generally, space radiation environments contain a great variety of different particles with energies ranging from several keV up to GeV and even beyond. The main contributors to space radiation are:
Trapped radiation in the Earth's magnetic field, forming radiation belts
Galactic Cosmic Rays (GCR) with low fluences, but high energies
Solar Cosmic Rays (SCR) that origin from the sun such as protons, alpha particles, electrons and heavy ions with energies up to hundreds of MeV.

Solar protons occur in high number but are most prominent with comparable low energies. GCR, on the other hand, generally show low fluxes but can have extremely high energies, high penetrating power and the potential of causing severe damage in electronics and harm to the crew.

Different effects contribute to the measured radiation: highly energetic primary particle radiation originating from Solar Proton Events and Galactic Cosmic Radiation; these are e.g. energetic protons, alpha-particles, electrons and also high Z ions, and secondary particle radiation caused by interaction of primary particle radiation with the wall material of spacecrafts. The main constituents for secondary particle radiations are neutrons.

Radiological protection of astronauts needs to account for the special characteristics of the radiation environment that is present in space and along interplanetary flights. Common radiation quantities such as the Effective Dose do not fully account for GCR, as GCR are of no concern in radiological protection of the general public on Earth. The Earth's atmosphere and its magnetic field both provide an efficient shielding against the majority of highly energetic particles that traverse space. In space, however, no such natural shielding exists. Thus, GCR are a major contributor to the overall dose in space.

Historically, the development of spacecraft structures took place from conservative metallic constructions, derived from aircraft engineering. Dominating metallic material is aluminium, alloys made from it and aluminium-base metal matrix composites. Unmanned spacecrafts typically have a shielding depth of about 1 g/cm². The shield that had been used for the Apollo missions provided for a shielding depth of 4.5 g/cm². The aluminium based ISS structure provides a shielding depth of 10-100 g/cm². In a solar cycle independent design, a shield of aluminium of approximately 30 g/cm² will be sufficient to give the required combined protection from both the Solar Proton Events and Galactic

Cosmic Radiation events. However, a shield of 30 g/cm² would result in high mission costs.

With progress in carbon fiber reinforced polymer material technology the metallic construction has been replaced more and more by the application of high-performance fiber-reinforced organic matrix composites. Mechanical strength and stiffness of carbon fiber reinforced polymer materials roughly are more than 50% higher compared to adequately dimensioned metallic constructions, and consequently mass saving is significant, also roughly more than 50%; Widely used resins are epoxies, polyimides and cyanate esters. Structures are fabricated by fiber layup, (split-) tape layup and lamination of Pre-pregs.

Currently, new concepts of structural design of very large space structures are under development, e.g, inflatable, balloon-like habitat modules. For example during NASA TransHab programme a 30 cm thick inflatable shell was developed, which is composed of 24 layers with individual material properties that fulfil multiple functions such as structural integrity, thermal insulation, impact protection, fire resistance and radiation shielding.

The object of the present invention is to provide a material with an improved radiation shielding effect, particularly with a radiation shielding absorbing the constituents of secondary particle radiation (e.g. neutrons) as efficiently as possible.

To solve the problem, the present invention provides in a first aspect a radiation shielding material, comprising a fibre material and a radiation damping filler, wherein the amount of the radiation damping filler is 40 to 95 wt. % based on the dry weight of the radiation shielding material.

The radiation damping material is a lightweight material that has a good stability and is easily applicable. The fibre material forms a matrix that supports a high packing density of the radiation damping filler. The high wt. % of the radiation damping filler provides an effective radiation shielding, particularly for shielding of particle radiation.

Additional advantageous configurations and further developments of the radiation shielding material are defined in the features of the dependent claims.

The fibre material can be a fibre material conventional in papermaking. The advantage of this type of matrix is that the radiation shielding material can be produced relatively easy by a flexible process at room temperature, which allows integrating radiation damping fillers into the matrix at high contents.

Preferably, the fibre material consists of organic fibres, particularly preferably cellulose fibres. This type of fibre material forms a matrix that provides particularly high contents of fillers. The properties of the radiation shielding material are thus determined substantially by the properties of the radiation damping filler.

A particularly high retention of the radiation damping filler can be provided by cellulose fibres consisting of a chemical pulp mixture of long fibre cellulose and short fibre cellulose, preferably a 40:60 mixture.

A high shielding effect can be provided by the radiation damping filler being present from 60-90 wt % based on the dry weight of the radiation shielding material, even more preferably from 80-90 wt %.

An effective shielding of particle radiation can be provided by the radiation damping filler being selected from the group of boron and/or boron compounds and/or alkali metal hydrides, or mixtures thereof.

Specific radiation damping fillers can be selected from Lithium borohydride (LiBH₄), Ammonia borane (H₃NBH₃), Boron (B), preferably ¹⁰B, hexagonal Boron nitrate (h-BN), Boron carbide (B₄C) or Lithium hydride (LiH), or mixtures thereof. Said radiation damping fillers show particularly effective shielding properties for particle radiation. Boron (B), hexagonal Boron nitrate (h-BN) and Boron carbide (B₄C) are especially safe and easily handled in production and use of the radiation shielding material, as they are not water-reactive and can be used in an aqueous process, such as papermaking, without further treatment. The water-reactive materials can also be used in aqueous processes, after sufficient encapsulation, e.g. with polyethylene.

For supporting the retention of the radiation damping filler in the matrix and providing a high packing density the radiation damping filler can be present in a particle size from 0.4-30 μm, preferably from 0.6-10 μm.

High radiation damping filler contents can be provided when Boron is present in a particle size (d50; laser diffraction) from 1-2 μm and/or when Boron carbide is present in a particle size from 1-2 μm and/or when hexagonal Boron nitrate is present in a particle size from 4-6 μm.

For a high shielding effect of the radiation shielding material the purity of the radiation damping filler can be 85-100%, preferably 95-99%.

The stability of the matrix and the retention of the radiation damping filler can be supported by at least one binding agent, wherein the binding agent preferably is a starch and/or a latex, particularly preferably a cationic starch and/or a negatively charged latex.

Retention of the radiation damping filler can be particularly high, when at least one retention agent is comprised, wherein the retention agent preferably is a cationic polymer, particularly preferably a cationic polyacrylamide.

Good stability and high radiation damping filler contents can be provided by the radiation shielding material comprising a cationic starch, a cationic polyacrylamide and styrene butadiene latex.

In an advantageous embodiment the radiation shielding material comprises or consists of:

a fibre material, preferably cellulose fibres: 6.5-7.5 wt %
a cationic starch, preferably maize starch: 0.5-1 wt %
a cationic polymer, preferably polyacrylamide: 0.05-0.1 wt %
a latex, preferably styrene butadiene latex: 2-3%
a radiation damping filler, preferably one described above in detail, particularly preferably boron carbide: 80-90 wt %

The radiation shielding material can be easily produced and used in various applications when it is a flat paper with a thickness of 0.2-4 mm, preferably 0.4-3 mm, particularly preferably 1-2 mm. At the same time an effective radiation shielding effect is provided.

High stability of the radiation shielding material and an effective shielding can be provided when the radiation shielding material has a grammage of 40-1400 g/m², preferably 300-800 g/m², particularly preferably of 400-600 g/m².

A light weight material with good shielding properties can be provided with a radiation shielding material having a density of 0.5-1.7 g/cm³, preferably of 0.95-1.5 g/cm³.

The use of the material is simplified due to a higher stability of the radiation damping material when the radiation shielding material has a tensile strength of 1800-2000 N/m.

An advantageous radiation shielding material for use in various applications can be provided when it has a bending stiffness of 10-20 Nmm, preferably of 12-18 Nmm.

To avoid a loss of radiation damping filler over time and to make handling of the radiation shielding material easier, the radiation shielding material can be impregnated, preferably with an epoxy resin.

The invention is also concerned with a method for production of a radiation shielding material as described above, comprising the steps of:
mixing at least one fibre material conventional in papermaking, preferably containing cellulose fibres, and at least one radiation damping filler, preferably one described above in more detail, in a liquid medium, preferably water, to form a slurry, wherein the dry content in the slurry is preferably 15-35 wt %,
   adding at least one additive, preferably one described above, to the slurry to produce a bound slurry,
   processing the bound slurry to a paper, wherein the radiation damping filler is present from 40-95 wt % based on the dry weight of the paper. Calendaring of the paper can further enhance the properties of the material.

To provide an improved radiation shielding for the crew of aircrafts and spacecraft the invention is also concerned with an aircraft or spacecraft with a radiation shielding material, wherein at least one inner compartment of said aircraft or spacecraft is at least partially surrounded by the radiation shielding material.

An improved radiation shielding can easily be achieved, e.g. for existing aircrafts or spacecrafts, by covering at least one wall with the radiation shielding material. The radiation shielding material can easily be applied to any existing structure, e.g. as wall and ceiling liner.

The invention is described in greater detail below based on exemplaryembodiments by way of example only and without limitation.

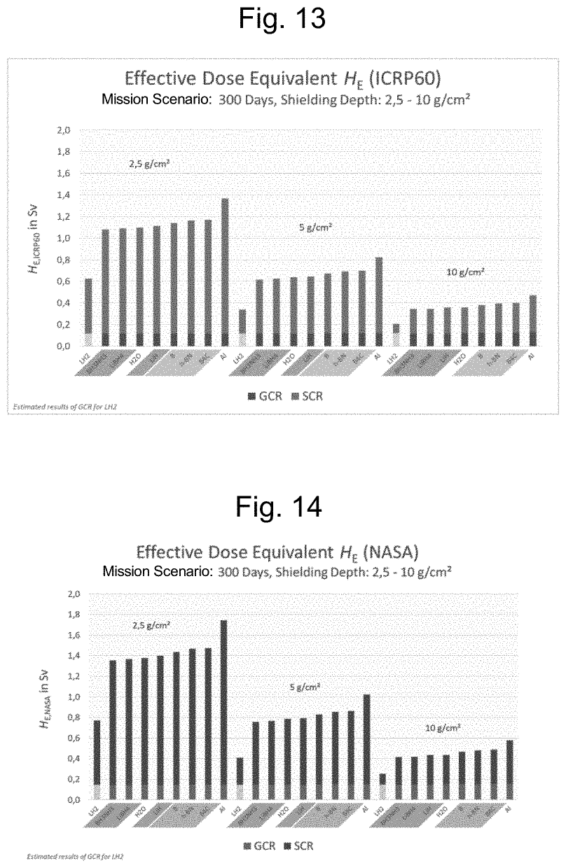

FIG. 13 shows the depth dose profile of effective dose equivalent for various materials using the quality factor according to ICRP60. Incident particles are GCR and SCR of the mission scenario.

FIG. 14 shows the depth dose profile of effective dose equivalent for various materials using the quality factor according to NASA. Incident particles are GCR and SCR of the mission scenario.

The dominant part of deep space radiation damage is caused by protons, helium and ions. Criterion for the selection of appropriate space radiation damping materials was to find materials with a high interaction cross section with protons. For pre-selection purposes the application of Material Indices are useful, The Material Index that was used for the selection of space radiation attenuating materials is defined as product of Z (charge number of the element), 1/p (where p is the density of the element) and the A^{-2/3} (where A is the atomic number of the element).

For shielding of particle radiation LiBH₂, BH₂NH₃ and LiH show very good Material Index numbers. However, they are water-reactive, so for paper production with water as liquid medium a suitable encapsulation of these grainy materials has to be provided when embedding them into the paper-based matrix.

B, h-BN and B₄C also show very good Material Indices for high particle radiation damping performance. All of them are stable in contact with water. These three materials where used for production of a radiation shielding material according to the invention.

### EXAMPLE 1

Production of a radiation shielding material according to the invention

For the development of the radiation shielding material the paper recipe was optimized (flocculation, drainage, retention, formation) targeted to a maximum filler content.

In a first step, laboratory sheets were made with elemental B, B₄C and h-BN as filler materials according to the recipe of Tab.1. No wet strength agents were used.

TABLE 1
Exemplary recipe for production of radiation shielding material

| | | Dosage |
|---|---|---|
| | Component | (%) |
| Fibre | Bleached chemical pulp mixture ZPR | 6.92 |
| matrix | Tear (long fibre cellulose)/Navia | |
| | (short fibre cellulose) 40:60 | |
| Filler | Elemental, amorphous Boron (B) | 90.0 |
| | (Grade I; H. C. Starck) Boron | |
| | carbide (B₄C) (Grade HD 07; H. C. | |
| | Starck) Hexagonal Boron nitride | |
| | (h-BN) (Grade F 15; H. C. Starck) | |
| Additives | Cationic maize starch (Bond HR | 0.50 |
| | 05946; Cargill) Cationic poly- | 0.085 |
| | acrylamide (cPAM) (Percol 540; | 2.50 |
| | BASF) Styrene butadiene (SB) | |
| | latex (Styronal D809; BASF) | |

a) Specifications of filler materials are shown in Table 2.

TABLE 2
Specifications of filler materials used for production
of exemplary radiation shielding material.

| Filler | Type | Particle size | Purity |
|---|---|---|---|
| B | amorphous, Grade I; | 1.0-2.0 μm | 95% |
| | H. C. Starck | | |
| B₄C | Grade HD 07; H. C. Starck | 1.0-2.0 μm | B:C ratio 3.8-4.0 |
| | | | (Theoretical 3.6) |
| h-BN | Grade F 15; H. C. Starck | 4.0-6.0 μm | 42.5-43.5% B |
| | | | (Theoretical 43.5%) |

All fillers were based on native Boron with a ¹⁰B content of 20%. The amount used was ˜1 kg of each filler. Boron was used as amorphous solid, but could be used crystalline as weft The particle size was measured by laser diffraction (D50). Suitable particle sizes range from 0.4-30 μm, preferably 1-10 μm. The filler material was used with a purity of 85-99%.

b) Preparation of Starch Solution

12.5 g cationic starch were sieved into 400 ml warm tap water under stirring. The dispersion was boiled 50 min at 95° C. and then cooled down to room temperature under occasionally slewing. The solution was filtered over a sieve under stirring in approx. 400 ml cold tap water and was further stirred another 10 min. The dry content was determined in 5 ml solution (target: approx. 1%).

c) Preparation of Latex Stock Solution

The original trade latex dispersion was diluted to 10% with deionized water according to the standard procedure.

d) Preparation of cPAM Stock Solution

0.5 g cPAM were added drop per drop to 50 ml H₂O under stirring. The solution was allowed to swell approx. 10 min. To prepare a solution for sheet forming purposes, the 1% standard solution was diluted with water 1:10. The pH of the solution must not exceed 5 (adjustment with diluted sulfuric acid).

e) Preparation of Matrix Solution

The chemical pulp was disintegrated using a standard disintegrator for 10 min. Subsequently, the consistency was adjusted to 0.5%. An aqueous filler slurry (dry content approx. 30%) was produced according to the standard procedure by stirring for 20 min at 2600 rpm.

f) Process Specifications

The paper samples were produced using a Rapid-Köthen laboratory sheet former that works in an aqueous system. In this example a round paper sheet with a diameter of 20 cm was produced. A modified Rapid-Köthen sheet former may be used for the production of square laboratory sheets e.g. with a format of 30 cm×30 cm.

The papermaking process consists of five main steps:
Filtration of the stock solution (mixture of raw materials, additives and water) over a wire
Couching of the wet sheet with a covering paperboard
Separation of the wet sheet from the wire material
Covering of the wet sheet with a second paper sheet
Drying with high temperature under vacuum.

e) Optionally, the paper obtained by these steps may be calendered.

The following calendering conditions were used:
Nip pressure: 91 kN/m
Temperature: 60° C.

### EXAMPLE 2

### Specifications of the Radiation Shielding Material of Example 1

The methods used for the characterization of the paper sheets are listed in Tab 3.

TABLE 3
Methodes used for characterization

| Parameter | Standard/Method |
|---|---|
| Grammage | DIN EN ISO 536 |
| Thickness, Density | DIN EN ISO 534 |
| Degree of densification | Calculated from the |
| by calendering | densities of calendered |
| | and uncalendered samples |
| Residue on ignition | DIN 54 370 |
| (525° C.) → filler content | |
| Tensile strength | DIN EN ISO 1924-2 |
| (relating to width) | |
| Bending stiffness | DIN 53 121 |

Material specifications were investigated. Filler content ranged from 80-90%. The exemplary paper sheets had a thickness of 1-2 mm, grammage ranged from 40-1,400 g/m², and density ranged from 0.5-1.7 g/cm³, with some of the sheets being calendered and others not.

The targets of the screening trials were the assessment of maximum Boron content. The intended (theoretical) filler content was set between 80 and 90 wt. %, at approx. 85%.

From the sum formula_{;} the boron content in the paper sheets was calculated:
Boron (100% Boron): 85%
Boron carbide (78.3% Boron): 66.6%
Boron nitride (43.5% Boron): 37.0%

The retention of B was lower and higher filler losses occurred, whereas the retention of B₄C and h-BN was very good. Based on the lower retention of B, its higher price and the higher Boron content of 8₄C in comparison with h-BN, it was decided to concentrate on papers highly filled with B₄C.

57 round paper sheets with a diameter of 20 cm were manufactured by the Rapid-Kothen method and characterized regarding their relevant properties (grammage, filler content, thickness, density, tensile strength and bending stiffness). The results of these tests are shown in Tab. 4 and Tab. 5.

TABLE 4
Specifications of tested paper sheets

| Sheet | Filler content | Mass | Grammage |
|---|---|---|---|
| designation | (wt.-%) | (g) | (g/m²) |
| BC_01 | 88.0 | 15.55 | 495.0 |
| BC_02 | 87.8 | 15.27 | 486.1 |
| BC_03 | 88.2 | 15.88 | 505.5 |
| BC_04 | 87.8 | 15.33 | 488.0 |
| BC_05 | 88.3 | 15.95 | 507.7 |
| BC_06 | 88.4 | 16.13 | 513.4 |
| BC_07 | 88.4 | 16.04 | 510.6 |
| BC_08 | 88.5 | 16.25 | 517.3 |
| BC_09 | 88.5 | 16.29 | 518.5 |
| BC_10 | 88.3 | 16.00 | 509.3 |
| BC_11 | 88.4 | 16.04 | 510.6 |
| BC_12 | 88.3 | 15.94 | 507.4 |
| BC_13 | 88.4 | 16.07 | 511.5 |
| BC_14 | 88.0 | 15.57 | 495.6 |
| BC_15 | 88.6 | 16.42 | 522.7 |
| BC_16 | 89.0 | 16.95 | 539.5 |
| BC_17 | 89.3 | 17.52 | 557.7 |
| BC_18 | 89.0 | 17.04 | 542.4 |
| BC_19 | 88.2 | 15.80 | 502.9 |
| BC_20 | 87.8 | 15.26 | 485.7 |
| BC_21 | 88.3 | 16.01 | 509.6 |
| BC_22 | 88.1 | 15.68 | 499.1 |
| BC_23 | 88.6 | 16.41 | 522.4 |
| BC_24 | 88.6 | 16.44 | 523.3 |
| BC_25 | 88.2 | 15.86 | 504.8 |
| BC_26 | 88.6 | 16.34 | 520.1 |
| BC_27 | 87.9 | 15.44 | 491.5 |
| BC_28 | 88.6 | 16.43 | 523.0 |
| BC_29 | 88.5 | 16.20 | 515.7 |
| BC_30 | 88.3 | 15.94 | 507.4 |
| BC_31 | 88.4 | 16.11 | 512.8 |
| BC_32 | 88.2 | 15.78 | 502.3 |
| BC_33 | 88.3 | 15.94 | 507.4 |
| BC_34 | 87.9 | 15.46 | 492.1 |
| BC_35 | 89.3 | 17.38 | 553.2 |
| BC_36 | 87.8 | 15.25 | 485.4 |
| BC_37 | 88.7 | 16.59 | 528.1 |
| BC_38 | 88.5 | 16.17 | 514.7 |
| BC_39 | 88.1 | 15.66 | 498.5 |
| BC_40 | 88.3 | 16.01 | 509.6 |
| BC_41 | 88.0 | 15.60 | 496.6 |
| BC_42 | 88.3 | 15.89 | 505.8 |
| BC_43 | 88.3 | 15.91 | 506.4 |
| BC_44 | 88.1 | 15.75 | 501.3 |
| BC_45 | 87.8 | 15.25 | 485.4 |
| BC_46 | 88.3 | 15.92 | 506.8 |
| BC_47 | 88.5 | 16.30 | 518.8 |
| BC_48 | 88.6 | 16.41 | 522.4 |
| BC_49 | 88.7 | 16.57 | 527.4 |
| BC_50 | 88.6 | 16.36 | 520.8 |
| BC_51 | 87.6 | 15.04 | 478.7 |
| BC_52 | 88.4 | 16.07 | 511.5 |
| BC_53 | 88.1 | 15.73 | 500.7 |
| BC_54 | 88.7 | 16.49 | 524.9 |
| BC_55 | 88.8 | 16.70 | 531.6 |
| BC_56 | 88.4 | 16.03 | 510.3 |
| BC_57 | 87.8 | 15.36 | 488.9 |
| Mean | 88.3 | 16.03 | 510.3 |
| Std. dev. (abs.) | 0.364 | 0.508 | 16.159 |
| Var. coeff. (%) | 0.41 | 3.17 | 3.17 |

TABLE 5
Influence of calendering

| | | Residue on | | | | | |
|---|---|---|---|---|---|---|---|
| | | ignition at | | | | Tensile | Bending |
| | Grammage | 525° C. | Thickness | Density | Densification | strength | stiffness |
| | (g/m²) | (%) | (μm) | (g/cm³) | (%) | (N/m) | (Nmm) |
| Before calendering | 508 | 87.7 | 501 | 1.02 | 15.7 | 1885 | 17.5 |
| After calendering | | | 422 | 1.21 | | 1984 | 12.5 |

Subsequently, some of the paper sheets were impregnated for better handling. A two-side metering bar coater type CHM was used for the impregnation of the highly filled paper sheets. The paper samples were saturated with epoxide resin for 3 minutes until complete deaeration. The excess resin was removed by two metering bars with a traverse speed of 8 rpm.

### EXAMPLE 3

### Comparison of the Radiation Shielding Material with Reference

The following scenario was used for comparison of the materials: The Space Radiation Environment Prediction Models have been applied for the prediction and specification of the space radiation environment for a “Round-trip Earth-Mars-Stay on Mars—and return to earth” in the years 2033/2034. The mission scenario used for testing the radiation shielding structure was a 300 days long flight from Mars to Earth from January 2034 to November 2034. This flight phase is the longest of all Round-trip-segments, and therefore, it is associated with the highest radiation absorption dose. Based upon the mission scenario for 2034, space radiation environmental data have been acquired from SPENVIS data base. The Space Environment Information System (SPENVIS) is an ESA operational software that provides a web-based interface for assessing the Space environment and its effects on spacecraft systems and crews. SPENVIS also includes extensive background information on the space environment and the environment models.

In general, one can distinguish physical quantities that can be measured or simulated (e.g. fluence ϕ or absorbed dose D) from radiological protection quantities (e.g. effective dose E or effective dose equivalent H_{E}). The latter cannot be measured directly, but radiological protection quantities are calculated from physical quantities by the use of quality or conversion factors.

While effective dose E works well as a radiological protection quantity for the broad public to account for all natural and occasional technical/medical irradiations it fails in appropriately reflecting the specific risks of an exceptional radiation environment such as space. In extraordinary environments, other radiological protection quantities are more useful. For the special case of radiation exposure of astronauts in space, ICRP Publication 123 recommends the use of the effective dose equivalent, H_{E}. The effective dose equivalent H_{E} uses quality factors that render the influence of special radiation environments in more detail and thus more accurately than radiation weighting factors.

The radiation environment for this scenario was calculated for selected particle types, i, e. the fluence of Solar Protons and of Galactic Cosmic Radiation Fluxes composed of protons, helium, carbon and iron dependent as function of their particle energy.

FIG. 13 and FIG. 14 show that aluminium is not the best radiation shielding for this scenario. For the same weight water (H₂O), Lithium borohydride (LiBH4), Ammonia borane (H3NBH3), Boron (B), preferably ¹⁰B, hexagonal Boron nitrate (h-BN), Boron carbide (B₄C) or Lithium hydride (LiH) outperformed the aluminium reference with better shielding performance.

The relevant radiation protection quantity, i.e. the effective dose equivalent H_{E} behind 5 g/cm² aluminium is about 0.9 Sv or 1.1 Sv, thus the space crew would be exposed to a cumulative effective dose equivalent of 0.9 Sv (ICRP60) or 1.1 Sv during the return flight from Mars to Earth. For the radiation shielding materials the effective dose equivalent H_{E} behind the radiation shielding material is about 0.7-0.8 Sv for ICRP60 and 0.8-0.9 Sv for NASA quality factors. BH₃NH₃ performed best out of the six materials. The neutron fluence was almost constant over shielding depth.

Shielding of Solar Cosmic Rays protons and Galactic Cosmic Rays protons shows different effectiveness: While all investigated materials attenuate Solar Cosmic Rays effectively with increasing shielding depth, Galactic Cosmic Rays levels remain almost constant. For the assumed mission scenario, the effective dose equivalent, H_{E} for Galactic 2U Cosmic Rays is 0.1 Sv, which is 10% of the total effective dose equivalent, H_{E} at a shielding depth of 5 g/cm².

The six materials divide into two groups: Water-soluble materials and water-reactive materials. The water-soluble materials B, h-BN and B₄C show a similar shielding performance of 0.8 times the effective dose equivalent, H_{E} of the Al reference at 5 g/cm². The water-reactive materials perform slightly better than the water-soluble ones. At a shielding depth of 5 g/cm², LiH, BH₃NH₃ and LiBH₄ generate about 0.75 times the effective dose equivalent, H_{E} of the Al reference.

Relative to aluminium, and for a shielding depth of 5 g/cm², the investigated materials provide 0.75-0.85 times the dose obtained using the aluminium reference shielding. For increasing shielding depth the shielding performance for the investigated materials performs significantly better compared to aluminium.

The results show that the radiation shielding material outperforms aluminium by delivering only 0.86-0.70 times the reference dose—depending on the material and the shielding depth.

Another object of the present invention is to provide a lightweight structure with an mproved radiation shielding effect, particularly with a radiation shielding absorbing the constituents of secondary particle radiation (e.g. neutrons) as efficiently as possible.

To solve the problem, the present aspect of the invention provides a radiation shielding structure, comprising a bottom layer and a top layer, wherein a hollow structure is sandwiched between the bottom layer and the top layer, wherein the hollow structure is filled with a radiation damping filler, particularly for shielding of particle radiation. The radiation damping structure is a lightweight structure that has a good stability and is easily applicable. The hollow structure supports a high packing density of the radiation damping filler. The hollow structure is filled by filling the spaces between the walls of the hollow structure. Especially, any filler of the fillers as described above can be used.

Additional advantageous configurations and further developments of the radiation shielding structure are defined in the features of the dependent claims.

An advantageous stability of the radiation shielding structure can be achieved when the bottom layer and the top layer are essentially parallel to each other.

The filling of the radiation shielding structure is simplified when the hollow structure is made of a plurality of open ended cells, particularly with walls perpendicular to the bottom and/or top layer. The hollow structure thus the cells of the hollow structure can easily be filled.

A hollow structure with an improved stability is provided when the cross-section of the cells is hexagonal or circular or oval or rectangular and/or triangular or the walls of the cells are corrugated.

A stable hollow structure with a large volume can be provided by a honeycomb structure, preferably with a cell size of 2.5-5 mm, preferably 3-4 mm, particularly preferably 3.2 mm.

A high content of radiation damping filler and a high shielding effect can be provided when each cell has a volume of 0.05-1.00 ml, preferably 0.075-0.45 ml, particularly preferably 0.100-0.150 ml and/or when each cell is filled with the filler to at least 70 vol %.

The height of the hollow structure can range from 4-100 mm, preferably 10-50 mm, particularly preferably 10-20 mm, to provide good stability and high volume.

An advantageous lightweight radiation shielding structure can be provided when the hollow structure has a density of 25-60 kg/m³, preferably 35-55 kg/m³, particularly preferably 48 kg/m³.

In an advantageous embodiment, the hollow structure is made of an aramid-paper, preferably coated with a phenolic resin. The hollow structure can be particularly light and provide advantageous properties, e.g. fire resistance.

To provide a particularly high radiation shielding effect the weight of the radiation damping filler can be 55-75% of the total weight, preferably 60-70%.

To obtain a high radiation damping filler content, the radiation damping filler can be compacted, preferably to at least 60% of its close-packing of spheres volume, particularly preferably to 80%.

The radiation shielding structure is particularly effective for particle radiation when the radiation damping filler is selected from the group of boron and/or boron compounds and/or alkali metal hydrides, or mixtures thereof.

When the radiation damping filler is selected from Lithium borohydride (LiBH4), Ammonia borane (H₃NBH₃), Boron (B), preferably ¹⁰B, hexagonal Boron nitrate (h-BN), Boron carbide (B4C) and/or Lithium hydride (LiH), or mixtures thereof, the radiation shielding structure is particularly effective for shielding particle radiation. Boron (B), hexagonal Boron nitrate (h-BN) and Boron carbide (B₄C) are especially safe and easily handled in the production process and use of the radiation shielding structure.

A particularly effective radiation shielding structure with a high packing density and a high radiation damping filler volume can be provided when the radiation damping filler is present in a particle size (d 50; laser diffraction) from 0.4-30 μm, preferably from 0.6-10 μm. By using powders as radiation damping fillers the production of the radiation shielding structure is simplified.

An advantageous packing density can be provided when Boron is present in a particle size (d 50; laser diffraction) from 1-2 μm and/or Boron carbide is present in a particle size (d 50; laser diffraction) from 1-2 μm and/or hexagonal Boron nitrate is present in a particle size (d 50; laser diffraction) from 4-6 μm.

An effective shielding can be provided when the purity of the radiation damping filler is 85-100%, preferably 95-99%.

A stable and effective radiation shielding structure for use in various applications can be provided when the radiation shielding structure has a thickness of 5 to 50 mm, preferably 10 to 30 mm, particularly preferably 10 to 20 mm. The thickness is the extension between the outer surface of the bottom layer and the outer surface of the top layer.

The shielding effect of the radiation shielding material can further be improved when the top layer and/or the bottom layer are made of the radiation shielding material described above. Further or instead the hollow structure can be made of such a radiation shielding material.

According to an advantageous embodiment, the radiation shielding material contains boron carbide as radiation damping filler and the hollow structure is filled with Boron as radiation damping filler. Such a radiation shielding material can be easily produced, providing a save, lightweight structure with excellent shielding properties. The sandwich structure provides stability and the lightweight materials used yield a low overall density of the shielding.

To provide an improved radiation shielding for the crew of aircrafts and spacecraft the invention is also concerned with an aircraft or spacecraft with a radiation shielding structure as described above, wherein at least one inner compartment of said aircraft or spacecraft is at least partially surrounded by the radiation shielding structure.

An improved radiation shielding can easily be achieved, e.g. for existing aircrafts or spacecrafts, by covering at least one wall with the radiation shielding structure. The radiation shielding structure can be used as a panel e.g. as interior add-on panel.

To provide an improved radiation shielding for the crew of aircrafts and spacecraft the invention is also concerned with an aircraft or spacecraft with a radiation shielding material and/or a radiation shielding structure as described above, wherein at least one inner compartment of said aircraft or spacecraft is at least partially surrounded by the radiation shielding material and/or the radiation shielding structure.

The invention is described in greater detail below based on exemplary embodiments by way of example only and without limitation.

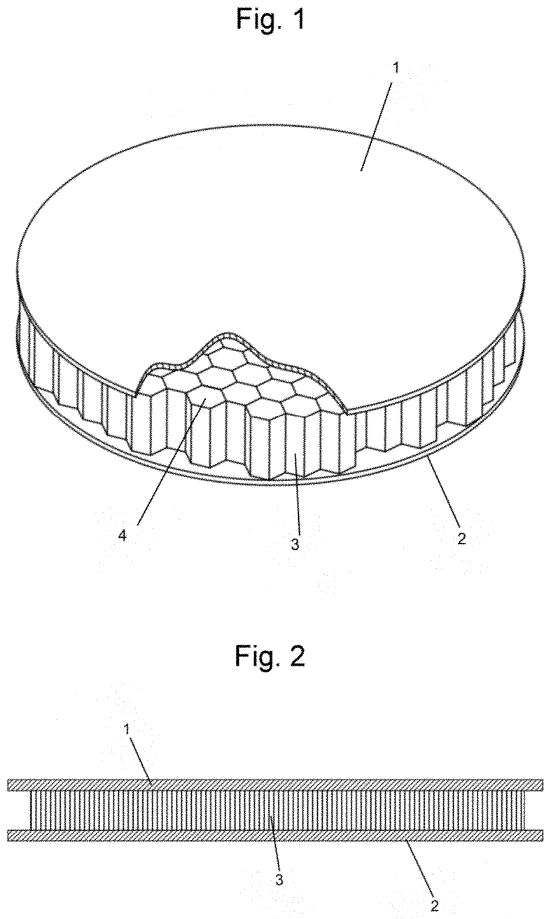

FIG. 1 shows a radiation shielding structure (RSS) according to the invention.

FIG. 2 shows a cross-section of the radiation shielding structure of FIG. 1.

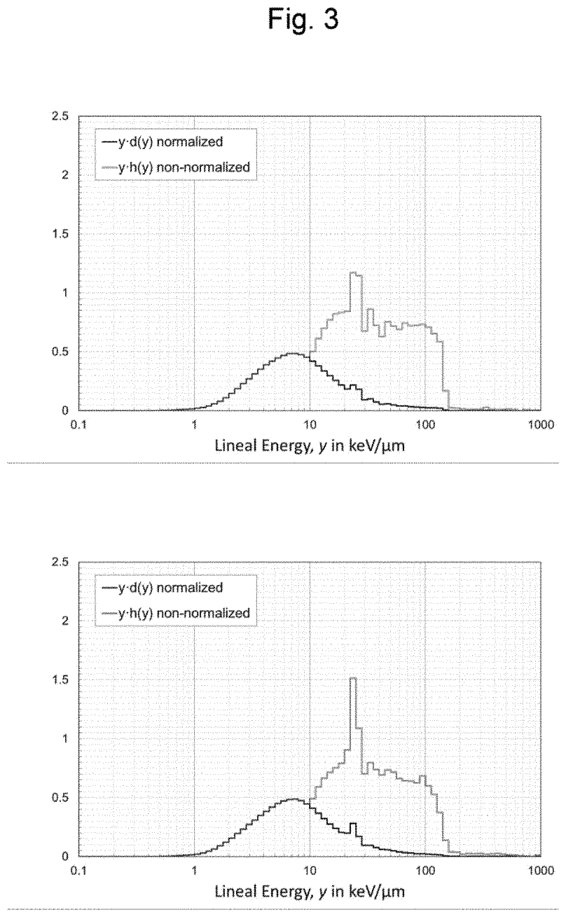

FIG. 3 shows a comparison of Microdosimetric Spectra: RSS vs. Aluminium at 100 MeV before the Bragg Peak.

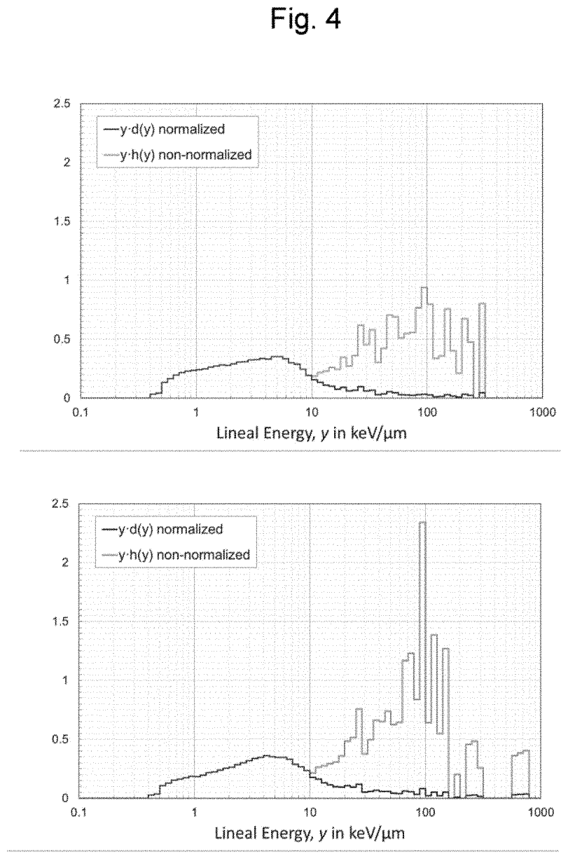

FIG. 4 shows a comparison of Microdosimetric Spectra: RSS vs. Aluminium at 100 MeV after the Bragg Peak.

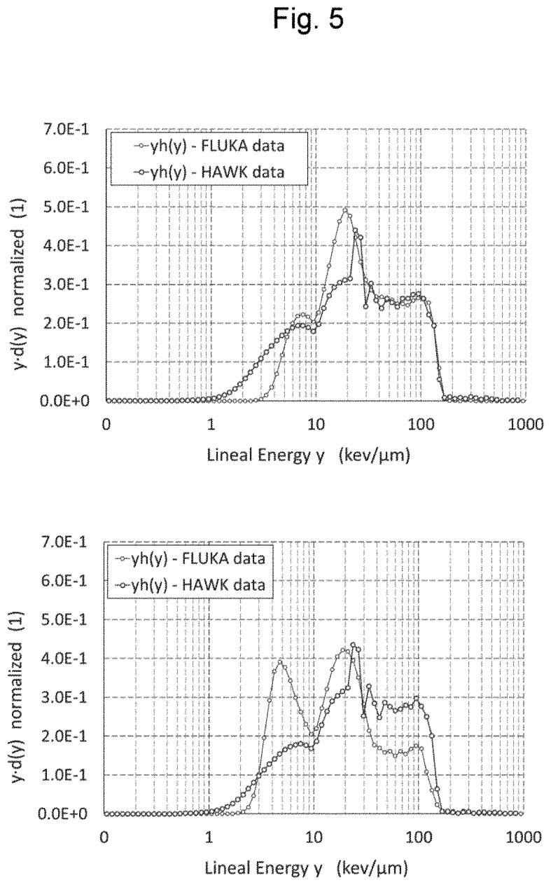

FIG. 5 shows a comparison of Microdosimetric Spectra: Measurement vs. Simulation at 75 MeV.

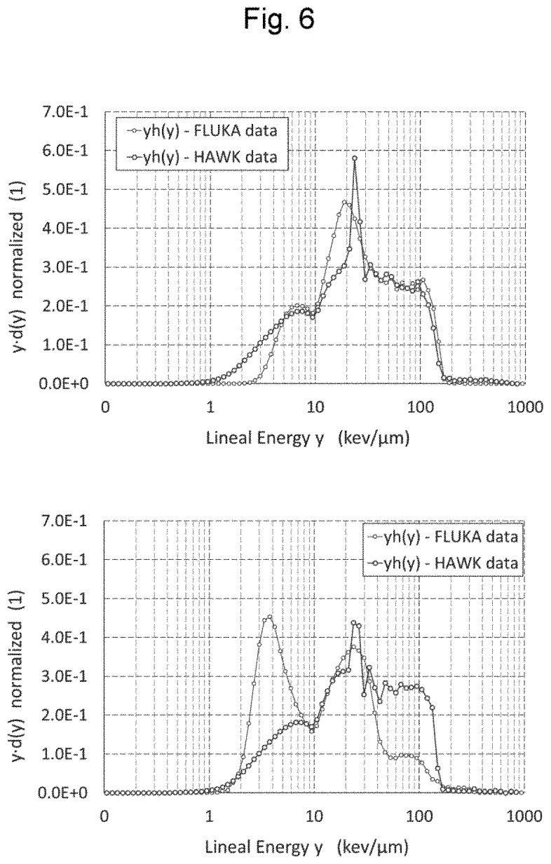

FIG. 6 shows a comparison of Microdosimetric Spectra: Measurement vs. Simulation at 100 MeV.

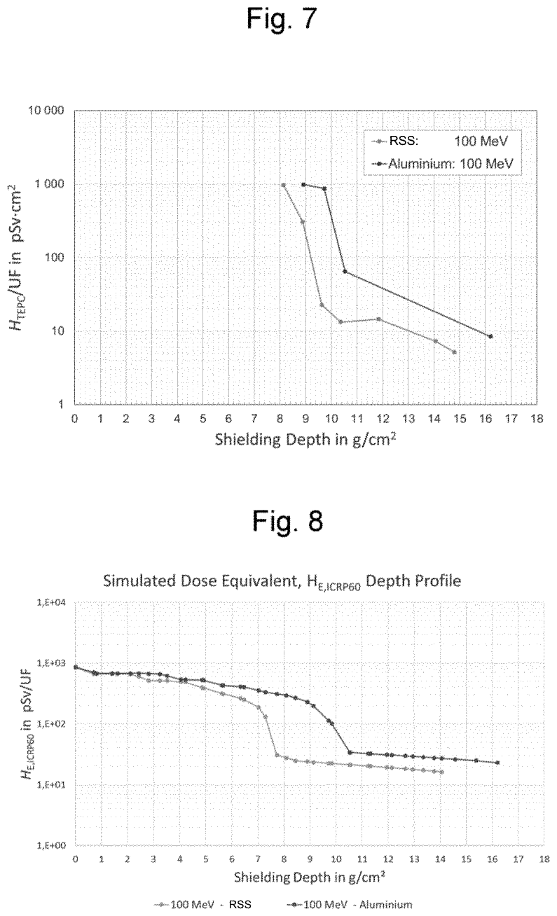

FIG. 7 shows the Dose Equivalent, H TEPC behind Shielding Layers vs. Shielding Depth with incident 100 MeV protons.

FIG. 8 shows the Depth Dose Profile of Effective Dose Equivalent, H_{E}, using the ICRP 60 quality factor with incident 100 MeV protons.

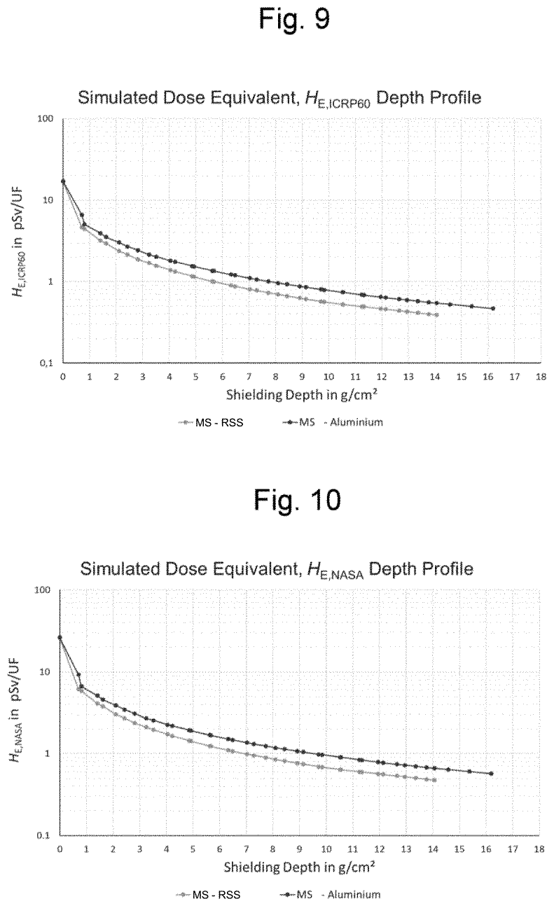

FIG. 9 shows the Depth Dose Profile of Effective Dose Equivalent, H_{E}, using the ICRP 60 quality factor with the radiation environment spectrum from the mission scenario.

FIG. 10 shows the Depth Dose Profile of Effective Dose Equivalent, H_{E}, using the NASA quality factor with the radiation environment spectrum from the mission scenario.

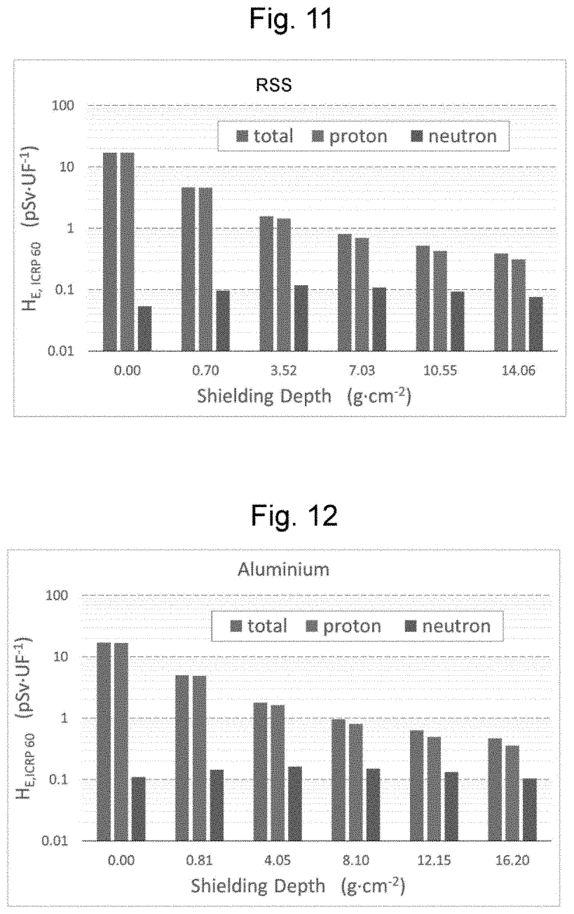

FIG. 11 shows the Effective Dose Equivalent, H_{E}, contribution of protons and neutrons compared to the total, behind RSS shielding using ICRP 60 quality factor and radiation environment spectrum from the mission scenario vs. shielding depths.

FIG. 12 shows the Effective Dose Equivalent, H_{E}, contribution of protons and neutrons compared to the total, behind Aluminium reference shielding using ICRP 60 quality factor and radiation environment spectrum from the mission scenario vs. shielding depths.

FIG. 1 shows a radiation shielding structure (RSS) according to the invention. The RSS has a bottom layer (2) and a top layer (1) that are parallel to each other. In an advantageous embodiment the bottom layer (2) and/or the top layer (1) can be made of a radiation damping material, e.g. produced according to Example 1. The radiation damping material may consist of a paper highly filled with BaC.

In the present embodiment of FIG. 1 a hollow structure (3) is sandwiched between the bottom layer (2) and the top layer (1). The hollow structure (3) is made of a plurality of open ended cells with walls perpendicular to the bottom and top layer (1.2). In the present embodiment the hollow structure (3) is a honeycomb structure.

The honeycomb structure is filled with a particle radiation damping filler (4). In the present embodiment the radiation damping filler is amorphous Boron.

FIG. 2 shows a cross-section of the radiation shielding structure of FIG. 1.

The radiation shielding structure of FIG. 1 can be produced according to Example 4.

### EXAMPLE 4

### Production of an Exemplary Radiation Shielding Structure (RSS)

In a first step, pre-trials were carried out to be able to define the process conditions for impregnation and gluing:

a) Materials

The following materials were used:
Laboratory sheets highly filled with B₄C (see Examples 1 and 2),
Hexagonal honeycomb material (Schütz Composites: CORMASTER® C1-3.2-48T, thickness: 14.3 mm; Nomex T412 (Poly(m-phenylen-isophthalamid) paper coated with a phenolic resin), pre-cut to round core material with a diameter of 200 mm.
Epoxide resin type L and curing agent type L (R&G Faserverbundwerkstoffe GmbH) were prepared according to the specifications of the manufacturer and used immediately.
Filling material: elemental Boron (powder; amorphous, Grade I, H.C, Starck). The specifications of the filler material are listed in detail hi Tab. 2.
WiPAK PET-A foil was used as a drying support.

b) Manufacturing procedure

The following procedure was carried out for the manufacture of the radiation shielding structure:
Impregnation of the bottom layer (2) with epoxide resin
Positioning of the hollow structure (3) on the bottom layer (2)
Drying semi-finished structure)
Filling of the semi-finished structure with radiation damping filler (4)
Impregnation of the top layer (1)
Positioning of the top layer (1) on the semi-finished structure, subsequent drying process

c) Step 1: Impregnation of the paper layers:

A two-side metering bar coater type CHM was used for the impregnation of the highly filled paper layers. Each of the paper samples was saturated with epoxide resin for 3 minutes until complete deaeration, The excess resin was removed subsequently by two metering bars (one bar with smooth surface for the bottom layer, one 0.6 mm bar for the top side) with a traverse speed of 8 rpm.

d) Step 2: Positioning and drying process:

The highly filled papers were impregnated with the epoxide resin, dried and glued to the honeycomb structure using the epoxide resin as adhesive. The impregnated sheets were placed on a flat sheet with the side containing more resin pointing upwards. Then a pre-cut honeycomb core was placed centric on the sheet. The composite was dried at room temperature under surface pressure of 59 N. In an additional step, the outer groove was brushed with epoxide resin and dried for 24 hours to seal the surface, resulting in the semi-finished structure.

e) Step 3: Filling procedure:

The semi-finished structure was filled with elemental Boron. At first, 145 g Boron powder were deposited centrally on the honeycomb structure. The excess material was spread to the outside using a ruler and the filling material was densified as follows: two 22 cm×22 cm×1 cm medium density fibreboard plates were placed below and onto the RSS and 100 hits with a 70 g wooden hammer were applied to the upper plate.

Step 4: Impregnation and drying of the top layer:

The impregnation and drying of the top layer were carried out in analogy to the bottom layer, but here the side containing more resin was oriented downwards in the direction of the honeycomb core. In order to ensure a complete sealing, the side grooves were filled with some additional epoxy resin using a small paintbrush.

20 sandwich structures filled with Boron and two empty reference structures without Boron filling were manufactured.

### EXAMPLE 5

### Specifications of the RSS of Example 4

Table 6 and 7 show the mean values for the weight-parameters of 20 manufactured RSS samples with a mean diameter of 200 mm, and mean thickness of 15.2 mm. The average total mass of one RSS is 232 g. A diameter of 20 cm yields an average shielding depth of 0.74 g/cm² per RSS. Stacking of the RSSs allows achieving shielding depths ranging from 0.74 g/cm² to 14.8 g/cm². The average thickness of one RSS is 1.6 cm. The whole stack of 20 RSSs has a total length of 32 cm.

TABLE 6
Specifications of the RSS

| | | | | Mass of | | | | | |
|---|---|---|---|---|---|---|---|---|---|
| | Dry mass of | Dry mass of | Mass of | empty | | Mass of | Mass of | Mass of | |
| | bottom B₄C | top B₄C | empty | structure + | Mass of | honeycomb | epoxide | Boron | Total |
| Sample | paper layer | paper layer | structure | filling | B₄C paper | structure | resin | filling | mass |
| No. | (g) | (g) | (g) | (g) | (g) | (g) | (g) | (g) | (g) |
| Bor-1 | 15.6 | 15.3 | 46.2 | 195.7 | 30.8 | 21.5 | 39.0 | 149.5 | 219.3 |
| Bor-2 | 15.7 | 17.4 | 48.2 | 199.5 | 33.1 | 21.4 | 45.0 | 151.2 | 229.3 |
| Bor-3 | 16.1 | 15.5 | 49.0 | 191.5 | 31.5 | 21.6 | 45.0 | 142.5 | 219.0 |
| Bor-4 | 16.0 | 15.9 | 48.0 | 191.9 | 32.0 | 21.2 | 42.9 | 143.9 | 218.8 |
| Bor-5 | 16.3 | 15.8 | 51.1 | 208.9 | 32.1 | 23.5 | 47.4 | 157.8 | 237.3 |
| Bor-6 | 16.3 | 16.1 | 51.1 | 208.0 | 32.4 | 23.8 | 45.6 | 156.8 | 234.8 |
| Bor-7 | 16.0 | 16.1 | 52.4 | 211.2 | 32.2 | 23.8 | 48.6 | 158.8 | 239.5 |
| Bor-8 | 16.1 | 15.9 | 52.2 | 204.3 | 32.1 | 23.9 | 47.7 | 152.1 | 231.8 |
| Bor-9 | 16.3 | 16.3 | 51.1 | 208.1 | 32.6 | 24.0 | 45.5 | 156.9 | 235.0 |
| Bor-10 | 16.0 | 16.4 | 51.0 | 205.8 | 32.4 | 23.7 | 46.6 | 154.8 | 233.8 |
| Bor-11 | 16.3 | 15.4 | 51.1 | 204.0 | 31.7 | 22.8 | 45.2 | 152.9 | 229.8 |
| Bor-12 | 15.3 | 16.0 | 48.8 | 204.3 | 31.3 | 23.0 | 45.3 | 155.5 | 232.1 |
| Bor-13 | 15.8 | 16.7 | 47.9 | 209.6 | 32.5 | 21.4 | 44.8 | 161.8 | 239.0 |
| Bor-14 | 15.9 | 16.5 | 49.5 | 207.0 | 32.4 | 21.4 | 46.4 | 157.6 | 236.3 |
| Bor-15 | 15.9 | 16.6 | 48.2 | 202.7 | 32.5 | 21.3 | 43.9 | 154.6 | 230.9 |
| Bor-16 | 15.6 | 16.4 | 48.6 | 203.6 | 32.0 | 21.7 | 45.1 | 154.9 | 232.0 |
| Bor-17 | 16.0 | 15.0 | 47.8 | 206.5 | 31.1 | 21.1 | 43.6 | 158.7 | 233.3 |
| Bor-18 | 15.7 | 16.1 | 48.2 | 204.1 | 31.7 | 20.9 | 44.9 | 155.8 | 232.5 |
| Bor-19 | 16.2 | 15.7 | 48.3 | 206.3 | 31.9 | 21.2 | 43.6 | 158.0 | 233.6 |
| Bor-20 | 16.6 | 15.3 | 49.8 | 207.4 | 31.8 | 21.4 | 46.3 | 157.6 | 235.8 |
| Mean | 16.0 | 16.0 | 49.4 | 204.0 | 32.0 | 22.2 | 45.1 | 154.6 | 231.7 |
| Std. dev. | 0.3 | 0.6 | 1.7 | 5.5 | 0.5 | 1.2 | 2.0 | 4.8 | 6.1 |
| (abs.) | | | | | | | | | |
| Var. | 2.0 | 3.6 | 3.4 | 2.7 | 1.7 | 5.2 | 4.5 | 3.1 | 2.6 |
| coeff. | | | | | | | | | |
| (%) | | | | | | | | | |

TABLE 7
Specifications of reference structure

| | Dry mass of | Dry mass of | | Mass of | Mass of | |
|---|---|---|---|---|---|---|
| | bottom B₄C | top B₄C | Mass of | honeycomb | epoxide | Total |
| Sample | paper layer | paper layer | B₄C paper | structure | resin | mass |
| No. | (g) | (g) | (g) | (g) | (g) | (g) |
| Ref-1 | 17.0 | 16.5 | 33.5 | 21.1 | 45.1 | 78.6 |
| Ref-2 | 17.0 | 17.5 | 34.6 | 21.1 | 46.2 | 80.7 |

Table 8 shows the chemical composition of a RSS sample.

TABLE 8
Chemical Composition of the RSS

| | | | Aramid- | |
|---|---|---|---|---|
| | | Epoxy | paper hollow | |
| | Paper Sheet | resin | structure | Filler |
| | C₁₂H₂₀O₁₀ + B₄C | C₁₈ H₁₉O₃ | C₁₄H₁₀N₂O₂ | B |
| Element | wt. % | wt. % | wt. % | wt. % |
| C | 24.0 | 76.3 | 70.6 | — |
| H | 1.0 | 6.7 | 4.2 | — |
| N | — | — | 11.8 | — |
| O | 6.0 | 17.0 | 13.4 | — |
| B | 69.0 | — | — | 100.0 |
| SUM | 100.0 | 100.0 | 100.0 | 100.0 |

The paper sheets consist mainly of cellulose fibres and Boron carbide (the content of latex, cationic starch and cPAM used in the manufacturing process can be neglected). The Boron carbide content of the paper sheets (approx. 88 mass percent) was determined by ashing. The elemental composition of the paper sheets was calculated subsequently from the mass shares and the theoretical sum formulas of cellulose and Boron carbide. The elemental composition of the different components (epoxy, meta-aramid) was calculated from their theoretical sum formulas available in the manufacturer data sheets or in the chemical literature. The mass shares of the paper sheet, the meta-aramid honeycomb, the epoxy resin and the Boron filler were determined by weighing during the different steps of the RSS manufacturing process. Accordingly, the overall elemental composition of the RSS was calculated.

### Example 6

### Testing of RSS of Example 4

The following scenario was used for comparison of the materials: The Space Radiation Environment Prediction Models have been applied for the prediction and specification of the space radiation environment for a “Round-trip Earth-Mars-Stay on Mars—and return to earth” in the years 2033/2034. The scenario used for testing the RSS was a 300 days long flight from Mars to Earth from January 2034 to November 2034. This flight phase is the longest of all mission segments, and therefore, it is associated with the highest radiation absorption dose of the mission segments. Based upon the mission scenario for 2034, space radiation environmental data have been acquired from SPENVIS data base. The Space Environment Information System (SPENVIS) is an ESA operational software that provides a web-based interface for assessing the Space environment and its effects on spacecraft systems and crews. SPENVIS also includes extensive background information on the space environment and the environment models.

The following Space Radiation Environment Prediction Models have been applied for the prediction and specification of the space radiation environment for an assumed mission scenario: The ESP (Emission of Solar Protons) model, the PSYCHIC model (Prediction of Solar particle Yields for CHaracterizing Integrated Circuits), the CREME96 models, ISO-15390 model, i.e. GCR particle flux models.

The radiation environment for this scenario was calculated for selected particle types, i. e.

the fluence of Solar Protons and of Galactic Cosmic Radiation Fluxes composed of protons, helium, carbon and iron dependent as function of their particle energy.

Radiation hardness testing on Earth can only account for a limited segment of the complete radiation environment spectrum. Particle accelerators are limited in energy and may only accelerate one particle type at once. Compared to solar protons, GCR occur with small frequency. Furthermore, solar protons have energies that can be achieved in accelerator facilities with reasonable effort. Thus, protons were used for radiation testing of the RSS. The protons used for testing correspond to solar protons of the same energy.

For the experiments, monoenergetic protons with energies of 75 MeV, 100 MeV and 150 MeV were used, provided with a beam diameter of 12 cm FWHM.

The investigated RSS-Samples consist of sheets enriched with BaC and glued with epoxy to seal a Aramid-paper honeycomb core filled with elemental Boron. The sandwich structure provides stability and the lightweight materials used yield a low overall density of the shielding. The average volumetric density of a RSS is 0.46 g/cm³.

The reference material was Aluminium. Aluminium has a density of 2.7 g/cm³. Thus, a RSS of 16 mm thickness with 0.74 g/cm² shielding depth has equal shielding depth to a 2.74 mm-thick aluminium sheet. Although both stacks have similar shielding depth (14.8 g/cm² and 16.2 g/cm²) they differ by 26 cm in length (32 cm vs. 6 cm for RSS vs. aluminium).

Circular aluminum sheets with a diameter of 20 mm and a thickness of 3 mm served as a reference for the shielding performance investigations. With a thickness of 3 mm, one sheet has similar shielding depth to one RSS (Al: 0.81 g/cm²; RSS: 0.74 g/cm²). For the experiments, a total of 20 aluminium reference sheets were manufactured that allow shielding depths between 0.81 g/cm² and 16.2 g/cm².

The chemical composition of the reference material is shown in Tab. 9.

TABLE 9
Chemical composition of Aluminium -
reference (Al99.5/AW-1050A/3.0255)

| Al | Si | Fe | Cu | Mn | Mg | Zn | Ti | others |
|---|---|---|---|---|---|---|---|---|
| in % | in % | in % | in % | in % | in % | in % | in % | in % |
| min | max | max | max | max | max | max | max | max |
| 99.5 | 0.25 | 0.40 | 0.05 | 0.05 | 0.05 | 0.07 | 0.05 | 0.03 |

The measurements were performed by a tissue equivalent proportional counters (TEPC). TEPCs are used to determine microdosimetric energy deposition spectra. Due to their tissue equivalence, dose distributions derived from TEPC measurements allow for a dose estimation for humans. The microdosimetry approach investigates distribution of radiation energy deposition in micrometer-size volumes of tissue, on cell-level scale.

The TEPC instrument used is a HAWK type manufactured by Far West Technology Inc. The detector itself is a gas filled proportional counter of spherical shape with a lower threshold of 0.5 keV/μm and an upper threshold of 1024 keV/μm. The wall of the detector is made of conducting tissue equivalent plastic (A150). The inner diameter of the sphere is 125 mm. The gas cavity is filled with pure propane gas at low pressure (933.2 Pa) and represents a tissue site size of about 2.16 μm. The detector sphere and the required electronics are contained in a cylindrical structure made of stainless steel and aluminum.

The following set-ups were tested:
1. a stack of RSS with shielding depths ranging from 0 g/cm² to 14.8 g/cm² in front of a TEPC
2. a stack of aluminium reference sheets with shielding depths ranging from 0 g/cm² to 16.2 g/cm² in front of a TEPC
3. the TEPC without shielding for background measurements with no proton beam

Further, a numerical simulation of the TEPC detector response behind the RSS and reference shielding being exposed to monoenergetic protons was carried out, as well as to protons having an energetic distribution representative for the assumed mission scenario. For all simulation-investigations, the Monte Carlo Code FLUKA was used.

The test set-up proton beam was modelled for the two nominal proton energies of 75 MeV and 100 MeV. The proton beam used at the facility has been characterised directly before the experiments by measuring beam profiles along the horizontal and vertical main axis of the radiation field. To assess the beam divergence the lateral characterisation of the beam profiles was performed in two planes that are separated 30 cm from each other. The first layer was positioned 5 cm from the last ionisation chamber being used for beam diagnostics, while the second plane was located another 30 cm downstream, thus in a distance of 35 cm from the last ionisation chamber.

For depth dose investigation the numerical source was modelled as a pencil beam that impinges in the centre of the front-side of the shielding set-up. Also, for these simulation the lateral extend of the RSS shielding set-up and also of the Aluminium reference set-up increased. The usage of a pencil beam and the lateral extension of the set-up was done to minimise border effects that might appear due to a limited lateral extend of the shielding set-up. After conduction of the numerical investigations, the results were renormalized properly in order to be presented correctly per unit incident proton fluence.

An overview on the simulations performed with respect to test set-up and depth dose profile modelling using a RSS model and an Aluminium reference model is presented in Table 10.

TABLE 10
Overview on the simulations performed with respect to Test set-up and depth
dose profile modelling using a RSS model and an Aluminium reference model.

| | Energy/Spectrum | Shielding Model | |
|---|---|---|---|
| Set-Up | Type | Type | Shielding Depth (g/cm²) |
| Test | 75 MeV | RSS | 4.44, 5.18, 5.92 |
| set-up | | Aluminium | 4.86, 5.67, 6.48, 16.20 |
| | | Reference | |
| | 100 MeV | RSS | 8.14, 8.88, 9.62, 10.36, 11.84, 14.80 |
| | | Aluminium | 8.91, 9.72, 10.53, 16.20 |
| | | Reference | |
| Depth | 75 MeV | RSS | 0.000, 0.703, 1.406, 2.109, 2.812, 3.515, 4.218, 4.921, |
| Dose | | | 5.624, 6.327, 7.030, 7.733, 8.436, 9.139, 9.842, 10.545, |
| | | | 11.248, 11.951, 12.654, 13.357, 14.060 |
| | | Aluminium | 0.000, 0.810, 1.619, 2.429, 3.239, 4.048, 4.858, 5.668, |
| | | Reference | 6.477, 7.287, 8.097, 8.906, 9.716, 10.526, 11.335, 12.145, |
| | | | 12.955, 13.764, 14.574, 15.384, 16.193 |
| | 100 MeV | RSS | 0.000, 0.703, 1.406, 2.109, 2.812, 3.515, 4.218, 4.921, |
| | | | 5.624, 6.327, 7.030, 7.733, 8.436, 9.139, 9.842, 10.545, |
| | | | 11.248, 11.951, 12.654, 13.357, 14.060 |
| | | Aluminium | 0.000, 0.810, 1.619, 2.429, 3.239, 4.048, 4.858, 5.668, |
| | | Reference | 6.477, 7.287, 8.097, 8.906, 9.716, 10.526, 11.335, 12.145, |
| | | | 12.955, 13.764, 14.574, 15.384, 16.193 |
| | Mission | RSS | 0.000, 0.703, 1.406, 2.109, 2.812, 3.515, 4.218, 4.921, |
| | scenario | | 5.624, 6.327, 7.030, 7.733, 8.436, 9.139, 9.842, 10.545, |
| | | | 11.248, 11.951, 12.654, 13.357, 14.060 |
| | | Aluminium | 0.000, 0.810, 1.619, 2.429, 3.239, 4.048, 4.858, 5.668, |
| | | Reference | 6.477, 7.287, 8.097, 8.906, 9.716, 10.526, 11.335, 12.145, |
| | | | 12.955, 13.764, 14.574, 15.384, 16.193 |

Results for the absorbed dose D and dose equivalent H derived by the TEPC as well as the quality factor Q for background measurements, stacks of aluminium reference material and stacks of RSS for 75 MeV, 100 MeV and 150 MeV incident protons are shown in Tables 11 and Table 12.

Table 11 summarizes the results for the absorbed dose D and the dose equivalent H derived from measurements with the TEPC as well as the quality factor, Q for aluminium reference shielding.

TABLE 11
Results: Summary on Aluminium Reference Shielding

| | | Irradiation | Proton | Mean | Total | Shielding | | | | |
|---|---|---|---|---|---|---|---|---|---|---|
| | | Time | Energy | Flux | Fluence | Depth | | D_{TEPC}/UF | H_{TEPC}/UF | |
| ID | Material | min | MeV | p/cm²/s | p/cm² | g/cm² | Layers | pGy · cm² | pSv · cm² | Q |
| A01 | Al99.5 | 10 | 75 | 1 181 | 7.1E+05 | 16.20 | 20 | 2.37 | 6.38 | 2.69 |
| A02 | Al99.5 | 10 | 100 | 1 354 | 8.1E+05 | 16.20 | 20 | 2.79 | 8.45 | 3.03 |
| A03 | Al99.5 | 10 | 150 | 1 839 | 1.1E+06 | 16.20 | 20 | 199.70 | 288.83 | 1.45 |
| A04 | Al99.5 | 10 | 100 | 1 354 | 8.1E+05 | 9.72 | 12 | 254.74 | 866.16 | 3.40 |
| A05 | Al99.5 | 10 | 100 | 1 347 | 8.1E+05 | 10.53 | 13 | 18.67 | 64.63 | 3.46 |
| A06 | Al99.5 | 10 | 100 | 1 649 | 9.9E+05 | 8.91 | 11 | 375.81 | 980.78 | 2.61 |
| A07 | Al99.5 | 10 | 75 | 1 161 | 7.0E+05 | 5.67 | 7 | 134.08 | 484.08 | 3.61 |
| A08 | Al99.5 | 10 | 75 | 1 151 | 6.9E+05 | 6.48 | 8 | 10.55 | 27.86 | 2.64 |
| A09 | Al99.5 | 10 | 75 | 1 155 | 6.9E+05 | 4.86 | 6 | 445.47 | 1141.25 | 2.56 |

Table 12 summarizes the results for the absorbed dose D and the dose equivalent H derived from measurements with the TEPC as well as the quality factor, Q for RSS shielding.

TABLE 12
Results: Summary on Aluminium Reference Shielding

| | | Irradiation | Proton | Mean | Total | Shielding | | | | |
|---|---|---|---|---|---|---|---|---|---|---|
| | | Time | Energy | Flux | Fluence | Depth | | D_{TEPC}/UF | H_{TEPC}/UF | |
| ID | Material | min | MeV | p/cm²/s | p/cm² | g/cm² | Layers | pGy · cm² | pSv · cm² | Q |
| M01 | RSS | 10 | 75 | 1 401 | 8.4E+05 | 14.80 | 20 | 2.50 | 6.14 | 2.46 |
| M02 | RSS | 10 | 100 | 1 707 | 1.0E+06 | 14.80 | 20 | 2.12 | 5.17 | 2.44 |
| M03 | RSS | 10 | 150 | 1 939 | 1.2E+06 | 14.80 | 20 | 212.23 | 303.28 | 1.43 |
| M04 | RSS | 10 | 150 | 1 801 | 1.1E+06 | 14.06 | 19 | 202.08 | 288.70 | 1.43 |
| M05 | RSS | 10 | 100 | 1 245 | 7.5E+05 | 14.06 | 19 | 2.75 | 7.30 | 2.65 |
| M07 | RSS | 10 | 150 | 1 527 | 9.2E+05 | 13.32 | 18 | 208.25 | 297.10 | 1.43 |
| M08 | RSS | 10 | 100 | 1 223 | 7.3E+05 | 11.84 | 16 | 7.05 | 14.52 | 2.06 |
| M09 | RSS | 10 | 100 | 1 285 | 7.7E+05 | 8.14 | 11 | 361.80 | 966.26 | 2.67 |
| M10 | RSS | 10 | 100 | 1 172 | 7.0E+05 | 8.88 | 12 | 90.20 | 304.78 | 3.38 |
| M11 | RSS | 10 | 75 | 1 146 | 6.9E+05 | 8.88 | 12 | 4.34 | 10.82 | 2.50 |
| M12 | RSS | 10 | 100 | 1 245 | 7.5E+05 | 9.62 | 13 | 9.26 | 22.70 | 2.45 |
| M13 | RSS | 10 | 100 | 1 256 | 7.5E+05 | 10.36 | 14 | 7.06 | 13.24 | 1.87 |
| M14 | RSS | 10 | 75 | 1 264 | 7.6E+05 | 5.18 | 7 | 70.88 | 248.55 | 3.51 |
| M15 | RSS | 10 | 75 | 1 288 | 7.7E+05 | 5.92 | 8 | 9.16 | 20.05 | 2.19 |
| M16 | RSS | 10 | 75 | 1 194 | 7.2E+05 | 4.44 | 6 | 359.83 | 978.38 | 2.72 |

Massive particles like protons transfer energy by the inverse square of their velocity. The linear energy transfer (LET) peaks for low energies, just before the particle stops, forming the characteristic Bragg Peak in the Bragg Curve. By varying the particle energy, the Bragg Peak can be shifted along the material's depth. For polyenergetic particles the Bragg Peak is smeared out and no distinct peak is observed in the energy loss curve.

FIG. 3 shows RSS und aluminium microdosimetric spectra before the Bragg Peak. A significant amount of protons is stopped inside the material at sufficiently high shielding depths, leading to low overall doses behind the shielding. Although the primary 100 MeV protons are stopped, secondary particles, such as neutrons, protons, electrons, spallation ions, etc. can be produced successively inside the shielding.

FIG. 4 shows RSS und aluminium microdosimetric spectra after the Bragg Peak. Behind the Bragg Peak, the microdosimetric spectra of RSS and aluminium differ significantly. High-LET events are more prominent behind the aluminium shielding. Densely ionizing radiation with high LET is weighted stronger by q(γ), leading to a much higher quality factor Q behind the aluminium shielding: 3.03 vs. 2.44 for RSS. Although RSS has the lower shielding depth (14.8 g/cm² vs. 16.2 g/cm²), it provides less absorbed dose per unit fluence D/UF, 2.12 pGy·cm² vs. 2.79 pGy·cm², and less dose equivalent per unit fluence H/UF, 5.17 pSv·cm² vs. 8.45 pSv·cm².

FIG. 5 and FIG. 6 show a comparison of measured and simulation microdosimetric spectra of the lineal energy distribution of the absorbed dose, D, and dose equivalent, H, for incident protons of 75 MeV and 100 MeV and different shielding depths (4.44 g/cm²-8.91 g/cm²).

FIG. 7 shows that the RSS shows a better shielding performance compared to the Aluminium reference shielding for incident protons of 100 MeV and all investigated shielding depths between 4.4 g/cm² and 16.2 g/cm² by a factor of about 1.7. The steep flank in the dose equivalent, as seen in FIG. 7, occurs shortly after the Bragg Peak, where the incident protons are stopped in the material. The RSS provides better shielding against protons than an aluminium reference of same shielding depth.

FIG. 8 shows the effective dose equivalent H_{E} using the quality factor from ICRP 60 for a monoenergetic proton beam of 100 MeV. At the Bragg-Peak the incident protons are stopped, resulting in a significant exponential decrease in dose by more than one order of magnitude over only 3 g/cm² shielding depth variation. At all shielding depths, the RSS provides lower doses than aluminium of equal shielding depth.

FIG. 9 and FIG. 10 show the depth dose profile of effective dose equivalent, H_{E}, using the ICRP 60 and the NASA quality factor with the radiation environment spectrum from the mission scenario. Due to the mixed energy of the incident radiation, there is no single Bragg-Peak. Yet, it can be seen that also in the case of a mixed radiation field with a wide range of energies, the RSS outperform aluminium in terms of shielding performance by a factor of 1.4.

FIG. 11 and FIG. 12 show the effective dose equivalent, H_{E}, contribution of protons and neutrons to the total dose, behind RSS and Aluminium shielding using ICRP 60 quality factor and radiation environment spectrum from the mission scenario vs. shielding depths.

The RSS shielding show a significantly better shielding performance regarding incident protons and less neutrons behind the shielding compared to aluminium.

1. Radiation shielding material, particularly for shielding of particle radiation, comprising a fibre material and a radiation damping filler, characterized in that the amount of the radiation damping filler is 40 to 95 wt. % based on the dry weight of the radiation shielding material.

2. Radiation shielding material according to claim 1, wherein the fibre material is conventional in papermaking, preferably consisting of organic fibres, particularly preferably cellulose fibres, wherein preferably the cellulose fibres consist of a chemical pulp mixture of long fibre cellulose and short fibre cellulose, preferably a 40:60 mixture.

3. Radiation shielding material according to claim 1, wherein the radiation damping filler is present from 60-90 wt % based on the dry weight of the radiation shielding material, even more preferably from 80-90 wt %.

4. Radiation shielding material according to claim 1, wherein the radiation damping filler is selected from the group of boron and/or boron compounds and/or alkali metal hydrides, or mixtures thereof.

5. Radiation shielding material according to claim 1, wherein the radiation damping filler is selected from Lithium borohydride (LiBH4), Ammonia borane (H3NBH3), Boron (B), preferably 10B, hexagonal Boron nitrate (h-BN), Boron carbide (B4C) or Lithium hydride (LiH), or mixtures thereof.

6. Radiation shielding material according to claim 1, wherein the radiation damping filler is present in a particle size (d50) from 0.4-30 μm, preferably from 0.6-10 μm.

7. Radiation shielding material according to claim 1, wherein Boron is present in a particle size (d50) from 1-2 μm and/or Boron carbide is present in a particle size (d50) from 1-2 μm and/or hexagonal Boron nitrate is present in a particle size (d50) from 4-6 μm.

8. Radiation shielding material according to claim 1, wherein the purity of the radiation damping filler is 85-100%, preferably 95-99%.

9. Radiation shielding material according to claim 1, comprising at least one binding agent, wherein the binding agent preferably is a starch and/or a latex, particularly preferably a cationic starch and/or a negatively charged latex.

10. Radiation shielding material according to claim 1, comprising at least one retention agent, wherein the retention agent preferably is a cationic polymer, particularly preferably a cationic polyacrylamide.

11. Radiation shielding material according to any of claims claim 1, comprising a cationic starch, a cationic polyacrylamide and styrene butadiene latex.

12. Radiation shielding material according to claim 1 comprising or consisting of:
fibre material, preferably cellulose fibres: 6.5-7.5 wt %
cationic starch, preferably maize starch: 0.5-1 wt %
cationic polymer, preferably polyacrylamide: 0.05-0.1 wt %
latex, preferably styrene butadiene latex: 2-3%
radiation damping filler, particularly preferably boron carbide: 80-90 wt %

13. Radiation shielding material according to claim 1, wherein the radiation shielding material is a flat paper with a thickness of 0.2-4 mm, preferably 0.4-3 mm, particularly preferably 1-2 mm.

14. Radiation shielding material according to claim 1, wherein the radiation shielding material has a grammage of 40-1400 g/m², preferably 300-800 g/m², particularly preferably of 400-600 g/m².

15. Radiation shielding material according to claim 1, wherein the radiation shielding material has a density of 0.5-1.7 g/cm³, preferably of 0.95-1.5 g/cm³.

16. Radiation shielding material according to claim 1, wherein the radiation shielding material has a tensile strength of 1800-2000 N/m.

17. Radiation shielding material according to claim 1, wherein the radiation shielding material has a bending stiffness of 10-20 Nmm, preferably of 12-18 Nmm.

18. Radiation shielding material according to claim 1, wherein the radiation shielding material is impregnated, preferably with an epoxy resin.

19. A method for production of a radiation shielding material, comprising the steps of:
mixing at least one fibre material conventional in papermaking, preferably containing cellulose fibres, and at least one radiation damping filler, in a liquid medium, preferably water, to form a slurry, wherein the dry content in the slurry is preferably 15-35 wt %,
adding at least one additive to the slurry to produce a bound slurry,
processing the bound slurry to a paper, wherein the radiation damping filler is present from 40-95 wt % based on the dry weight of the paper,
preferably calendering of the paper.

20. A radiation shielding structure, particularly for shielding of particle radiation, comprising a bottom layer and a top layer, wherein a hollow structure is sandwiched between the bottom layer and the top layer, characterised in that the hollow structure is filled with a radiation damping filler.

21. Radiation shielding structure according to claim 20, wherein the bottom layer and the top layer are essentially parallel to each other.

22. Radiation shielding structure according to claim 20, wherein the hollow structure is made of a plurality of open ended cells, particularly with walls perpendicular to the bottom and/or top layer.

23. Radiation shielding structure according to claim 22, wherein the cross-section of the cells is hexagonal or circular or oval or rectangular or triangular and/or the walls of the cells are corrugated.

24. Radiation shielding structure according to claim 20, wherein the hollow structure is a honeycomb structure, preferably with a cell size of 2.5-5 mm, preferably 3-4 mm, particularly preferably 3.2 mm.

25. Radiation shielding structure according to claim 20, wherein each cell has a volume of 0.05-1.00 ml, preferably 0.075-0.45 ml, particularly preferably 0.100-0.150 ml and/or wherein each cell is filled with the filler to at least 70 vol %.

26. Radiation shielding structure according to claim 20, wherein the hollow structure has a height of 4-100 mm, preferably 10-50 mm, particularly preferably 10-20 mm.

27. Radiation shielding structure according to claim 20, wherein the hollow structure has a density of 25-60 kg/m³, preferably 35-55 kg/m³, particularly preferably 48 kg/m³.

28. Radiation shielding structure according to claim 20, wherein the hollow structure is made of an aramid-paper, preferably coated with a phenolic resin.

29. Radiation shielding structure according to claim 20, wherein the weight of the radiation damping filler is 55-75% of the total weight, preferably 60-70%.

30. Radiation shielding structure according to claim 20, wherein the radiation damping filler is compacted, preferably to at least 60% of its close-packing of spheres volume, particularly preferably to 80%.

31. Radiation shielding structure according to claim 20, wherein the radiation damping filler is selected from the group of boron and/or boron compounds and/or alkali metal hydrides, or mixtures thereof.

32. Radiation shielding structure according to claim 20, wherein the radiation damping filler is selected from Lithium borohydride (LiBH4), Ammonia borane (H3NBH3), Boron (B), preferably 10B, hexagonal Boron nitrate (h-BN), Boron carbide (B4C) and/or Lithium hydride (LiH), or mixtures thereof.

33. Radiation shielding structure according to claim 20, wherein the radiation damping filler is present in a particle size (d50) from 0.4-30 μm, preferably from 0.6-10 μm.

34. Radiation shielding structure according to claim 20, wherein Boron is present in a particle size (d50) from 1-2 μm and/or Boron carbide is present in a particle size (d50) from 1-2 μm and/or hexagonal Boron nitrate is present in a particle size (d50) from 4-6 μm.

35. Radiation shielding structure according to claim 20, wherein the purity of the radiation damping filler is 85-100%, preferably 95-99%.

36. Radiation shielding structure according to claim 20, wherein the radiation shielding structure has a thickness of 5 to 50 mm, preferably 10 to 30 mm, particularly preferably 10 to 20 mm.

37. (canceled)

38. Radiation shielding structure according to claim 20, wherein the radiation shielding material contains boron carbide as radiation damping filler and the hollow structure is are filled with Boron as radiation damping filler.

39. (canceled)

40. (canceled)
